(19) United States
(12) Patent Application Publication
(10) Pub. No.: US 2007/0106548 A1
(43) Pub. Date: May 10, 2007

(54) Internet based calendar system linking all parties relevant to the automated maintenance of scheduled events

(76) Inventor: Steven Leonard Bratt, Brush Prairie, WA (US)

Correspondence Address: Steven L. Bratt, 19411 NE 227th Ct, Brush Prairie, WA, 98606, US

(21) Appl. No.: 11/591,887

(22) Filed: Nov. 2, 2006

Related U.S. Application Data
(60) Provisional application No. 60/734,032, filed on Nov. 4, 2005.

(51) Int. Cl. G06F 15/02

(52) U.S. Cl. 705/9

(57) ABSTRACT

An Internet based system providing a variety of linked interfaces to several classes of users based on the needs of these user classes, the benefit of which being the automation of as many scheduling tasks as possible. These interfaces could include: A web based interface for home based users, a web based interface for small business users, an API for external software to submit data into the system, and a mechanism for users to upload a flat file of predetermined format into the system to communicate bulk scheduling data for one or many users. The system may also incorporate a targeted advertising engine to push focused advertising content to a specific users based on data collected from the system users they interact with.

### CROSS-REFERENCE TO RELATED APPLICATIONS

This application claims the benefit of PPA Ser. No. US60/734,032 filed Nov. 4, 2005

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the provisioning of Calendar or Personal Information Management (PIM) software functionality to several classes of users over the World Wide Web

2. Background of the Invention

The proliferation of the Internet has created many opportunities for both the hosting of useful applications and the sharing of data amongst a variety of systems. These factors have already started to have an impact on the field of Personal Information Management (PIM), a term which can broadly define all of the following devices: a binder based daily planner, a software application that provides general calendar, scheduling and note-taking functionality, and a class of small handheld computer systems that often host these applications (also called personal digital assistants, or PDA's).

Concurrent to these developments has been the recent trend towards providing traditionally standalone software applications via the Internet utilizing the World Wide Web (WWW). This method delivers a remote user interface for software located at a central location. The user interface is displayed by standards based web browser software now available on any personal computer, handheld computer, and even cell phones. The user interface can therefore be commonly referred to as a web based interface, which is typically provided by a series of webpages.

Therefore, PIM software can be now be divided into two categories: Software that runs on a local computer (full sized PC or handheld) with all the programs and scheduling data residing on that computer, or software provisioned over the Internet via a web based interface, with all programs and data residing on a central system of computers and displayed by a web browser. Web based software is sometimes provided with a per-month or other periodic use fee, or can be supported by advertising associated with the provided web based service.

Some advantages of web based software over traditional software would include:

a) The software service is typically available from any internet connected device equipped with web browsing software.

b) Specific software does not need to be loaded on individual devices.

c) Application data (e-mail messages, schedule appointments etc.) does not need to be synchronized between devices if a user wishes to use more than one device since the actual application is run at a central location where all the data resides.

Within the category of web based PIM software there are additionally two classes of calendar & scheduling software. The first class of web based software is geared to a population that can be called Home Based Users. These users encompass anyone seeking to organize the events and activities related to their personal life, as opposed to their place of business. This is therefore a very broad class of users, and there are several examples of web based calendar applications available to home based users in the prior art. Home based users can use products like backpack (www.backpackit.com), Yahoo Calendar (calendar.yahoo.com) and even Google Calendar (calendar.google.com)

The second class of web based software is geared to a population that can be called Small Business Users. These users encompass anyone managing or operating a small business. This software allows a small business to maintain their schedule, and often allows a client to make an appointment via a web based interface as well. Small business users can currently find products like 123Appointments (www.123appointments.com) and contact Office (www.contactoffice.com) in the prior art. A key limitation of this class of software is that the client needs to visit the small business user's web page to accomplish a scheduling task. They can not do it from within their own calendar application.

Large businesses do not typically fall into a class served by web based software except as outlined below. Large businesses that schedule appointments with end users or clients (airlines, HMO's etc.) generally have developed their own customized scheduling software to meet specific needs.

Regardless of the need to schedule appointments with clients, however, large businesses also commonly use an office communications suite like Microsoft's Exchange/Outlook platform or Novell's GroupWise. These tools allow employers to provide integrated scheduling and calendar functionality to their employees in their internal environments. These suites may also provide a web based interface so that employees can view & manage their work calendar when away from the office.

It should be pointed out that, despite the previously mentioned advantages that web based software has over traditional software in general, PIM software (web based or traditional) does not add significant new functionality compared to traditional manual methods like a small calendar in a purse, a desk blotter calendar, or a binder based business calendar. The end user is still responsible for manually maintaining most of the events placed in the calendar. If you wait on hold with your healthcare provider for 30 minutes in the car on your way to work to make a doctors appointment, you still need to remember to enter it in your calendar later, no matter what form of calendar you use (paper or electronic). Due to these factors, the penetration of web based PIM software into the average household has been low. While tech savvy users may make use of these new tools, there is no dramatic benefit drawing the average housewife or other head of household to these products.

Inventors have submitted and received patent protection for many topics related to the provisioning of or synchronization between calendar systems or devices. Typical applications that I reviewed detailed communications protocols for synchronizing events on PDA's, layered calendar displays, methods to integrate multimedia into PIM software, specific conflict resolution mechanisms for group scheduling, or targeted solutions for schedule integration challenges in specific industries etc. None of the reviewed prior art was of similar scope to the present patent application and all of the methods and objects of the current application can be accomplished without infringing on any of these prior inventions to the best of my knowledge.

### OBJECTS AND ADVANTAGES

What is necessary to make a web based PIM platform attractive, especially to the typical home based user, is a product that connects seamlessly to the multiple users classes (business and personal) the user plans events with. For example, a typical family needs to schedule events with the following classes of users: other home based users (play dates & birthday parties), small business users (the family dentist or hair dresser), large businesses (an HMO for a doctor's appointment or an Airline), other scheduling entities (a youth soccer league or hobby club), and even their work calendar maintained by a business communications suite (to alert the family of an early or late work meeting). No system currently exists with a goal to link together all these entities a family does business with. The present patent application provides the specifications for a “Connected Community Calendar” system that meets these needs. By providing a variety of linked interfaces based on the needs of both the home based user and these other classes of users, the connected community calendar toolset makes a host of functionality possible that is not represented in existing products. As such, a complete system that provides all or part of the described functionality can be referred to as a connected community calendar system.

For all subsequent descriptions, the following abbreviations are used: Connected Community Calendar (C3), Home Based Users (HBU), Small Business Users (SBU), Large Business Entities (LBE), Office Communications Suite (OCS), and Other Scheduled Entities (OSE).

Unique functionality made available by the C3 system would include, but is not limited to:
a) An HBU can make appointments with an SBU via the following methods:
   1) An HBU calls an SBU to make an appointment over the phone. The HBU is driving and has no access to the system while the SBU is accessing a web based C3 interface. Once an appointment is made in the SBU interface, the appointment appears automatically in both the SBU schedule and the HBU schedule.
   2) An HBU wishes to make an appointment with an SBU, and has access to C3 via any available interface. The HBU can view the SBU's available times in their own web based HBU interface and schedule an appointment without the SBU's participation. The scheduled appointment appears automatically in both the SBU schedule and the HBU schedule.
   3) An HBU calls an SBU to make an appointment over the phone. Again the HBU is driving and has no access to the system, so only the SBU is accessing the C3 interface. The HBU is not sure of their own availability on a specific day. The SBU can call up the HBU's availability in the SBU web based interface and verbally share this information with the HBU during the conversation. An appointment is made with confidence by the HBU that an appropriate time is selected. Once made in the SBU interface, the appointment appears automatically in both the SBU schedule and the HBU schedule.
b) An HBU can make appointments with an LBE via the following methods:
   1) An HBU calls an LBE to make an appointment over the phone. The LBE representative is using their own internal scheduling software. Once an appointment is made, the LBE system sends the appointment data over the Internet to the central C3 system. The appointment then appears automatically in the HBU schedule.
   2) An HBU uses an LBE's private or custom web based interface (not hosted by the C3 system) to make an appointment. Once an appointment is made, the LBE system sends the appointment data over the Internet to the central C3 system. The appointment then appears automatically in the HBU schedule.
   3) Likewise an HBU can contact an LBE via any method that the LBE supports. Once an appointment is posted to the LBE's internal system, it sends the appointment data over the Internet to the central C3 system. The appointment then appears automatically in the HBU schedule.
c) An HBU can receive schedule information from an OSE via the following methods (specific examples are provided for clarity in this class):
   1) An OSE (Hobby Club) schedules a single event for many users (a Quilting Show). The OSE can access a C3 provided web based interface to upload a file containing this bulk schedule data. The events then show up in the C3 interface for all HBU's associated with the OSE (The quilt show appears in the C3 interface for all club members using C3).
   2) An OSE (soccer league) completes the process to generate multiple scheduled events for multiple people (the soccer game schedule). The OSE can access a C3 provided web based interface to upload a file containing this bulk schedule data. All of the events then show up in the C3 interface for all HBU's associated with the events (all games show up in the C3 interface for all families using C3).
d) An HBU can receive schedule information from an OCS via the following method:
   1) An HBU family member has a work appointment that requires him or her to stay at work late. This appointment appears in their existing OCS schedule. The HBU selects this appointment in their OCS and activates a “Send to Home Calendar” function. The OCS system sends the appointment data over the Internet to the central C3 system. The appointment then appears automatically in the HBU family schedule.
e) An HBU can choose to share a view of specific calendar events or their entire calendar with other HBU's

Additionally, C3 would allow families to organize themselves logically as appropriate for different events. Depending on how their C3 data is shared with different participants, they can show up collectively as a single family unit, or as individual family members. A haircut appointment or soccer schedule may apply to individual family members, while an airline reservation for a family trip may show up once for the whole family.

With C3, there are concrete benefits available for all classes of users. The home based user knows that, no matter how they make an appointment with a C3 participant, it will appear accurately in their calendar or schedule the next time they access it from any location via any available method. In addition to a valuable tool to run their business, a small business user offers increased flexibility and improved accuracy to their C3 enabled clients. A large business entity offers improved customer service and appointment accuracy. Other Scheduling Entities get a new way to communicate their bulk or other unique events to multiple C3 clients at once. And finally home based users who also work have a way to link their work and home calendars when necessary.

Additionally a complete C3 system provides distinct financial possibilities for the entity hosting the C3 system. As stated above, many web based software systems are supported by advertisements displayed along with the desired service. The C3 infrastructure can increase the value of web based advertising by incorporating a targeted advertising engine. Information collected by C3 users can be used to push targeted advertising to users based on the business, industry or other characteristic of a user's scheduled events. Targeted advertising is inherently more valuable than blind advertising.

### SUMMARY

The Connected Community Calendar then comprises a variety of tools to meet the needs of all entities seeking to share calendar and scheduling systems with other entities. These tools include, but are not limited to, web based interfaces provided for some end user classes, as well as ‘back end’ communications layer interfaces for classes with their own scheduling systems.

### DRAWINGS—FIGURES

The accompanying figures provide flow charts detailing the steps for different classes of users to utilize the system. Each step in the process (flowchart box) is labeled first with a capital alphabetic step identifier in parenthesis. Steps that define a sub-class of an earlier step have a numeric sub-identifier, and additional sub classes of steps have a lowercase sub-identifier. Therefore the flowchart box describing a specific step in a specific figure can be completely described, for example, as “FIG. 1-E2b”

FIG. 1 provides a flow chart of the basic processes necessary for home based users to activate and use the C3 system.

FIG. 2 provides a flow chart of the basic processes necessary for small business users to activate and use the C3 system.

FIG. 3 provides a flow chart of the basic processes necessary for large business entities to activate and use the C3 system.

FIG. 4 provides a basic flow chart of the basic processes necessary for other scheduling entities to activate and use the C3 system.

FIG. 5 provides a flow chart of the basic processes necessary for office communications suite users to activate and use the C3 system.

FIG. 6 provides a flowchart detailing the configuration of custom scheduling applications for C3 Integration.

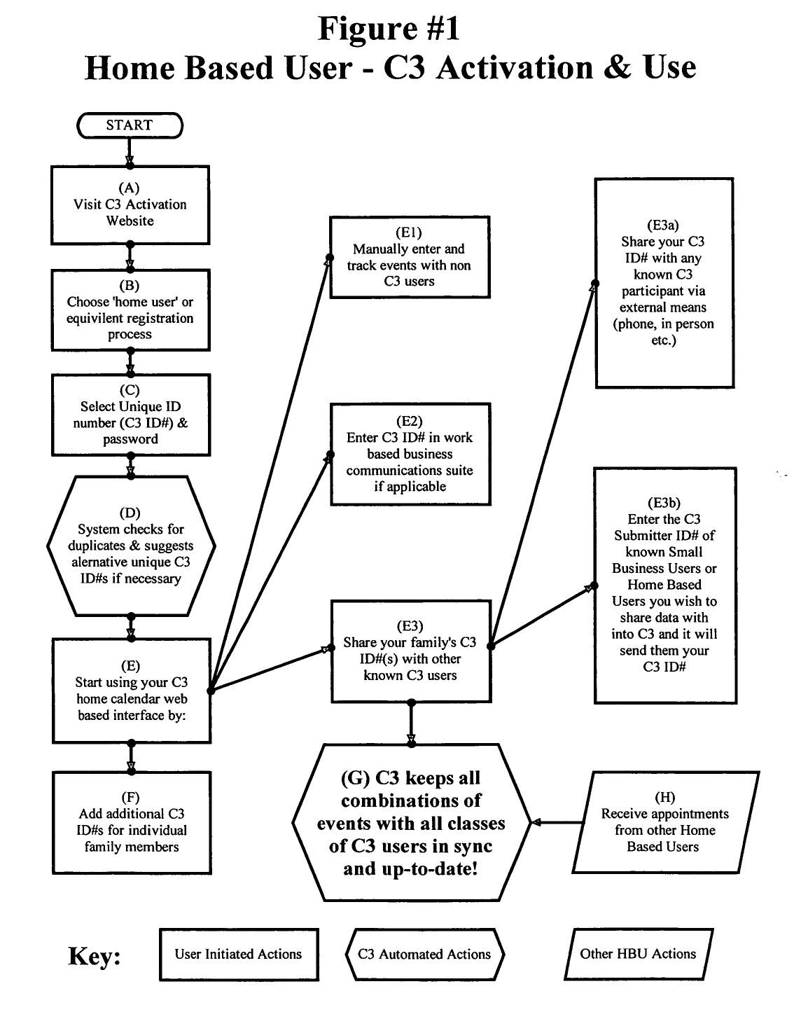

### DETAILED DESCRIPTION—FIGS. 1-6—PREFERRED EMBODIMENT

A C3 implementation would be supported by a computer infrastructure comprising web server(s), database server(s), communications server(s) and the software running on these systems necessary to provide the specified interfaces. The devices and methods (hardware and software) necessary to develop, host and support a web based infrastructure and secondary communications interfaces, all supported by a central database, is not unique to the C3 system. Such systems are in wide use today supporting thousands of Internet based applications. Likewise there are many common display layouts and designs in use for the display and management of calendar or scheduling systems (Personal Information Managers). This specification will therefore focus on the functional and interface requirements necessary to provide the novel interfaces between different classes of users that makes the C3 system unique.

Registration

The entity hosting C3 provides a web based interface (Seen in FIGS. 1-4, step A) for prospective users to learn about and register for C3 membership. The registration process may be different depending on the class of user (FIGS. 1-4, step B). Home based users, at a minimum, must be asked to select a unique ID# for identification purposes within the C3 system, hereby called the C3 ID# (FIG. 1-C). Additionally a password may be chosen to facilitate authentication of the user for any interface. The user may request a specific ID# or have one provided by the system. Any requested ID# must be checked against existing C3 ID#s in the system (FIG. 1-D) to insure the requested ID# is unique. The C3 system may place restrictions on the length of ID#s or limit the use of specific characters. The system may also allow users to use their e-mail address as a C3 ID#. Once registered in the system as a home based user, the C3 system will provide all appropriate interfaces for a user of that class, including but not limited to web based interfaces for standard personal computers, handheld computers (PDA's), or cell phones.

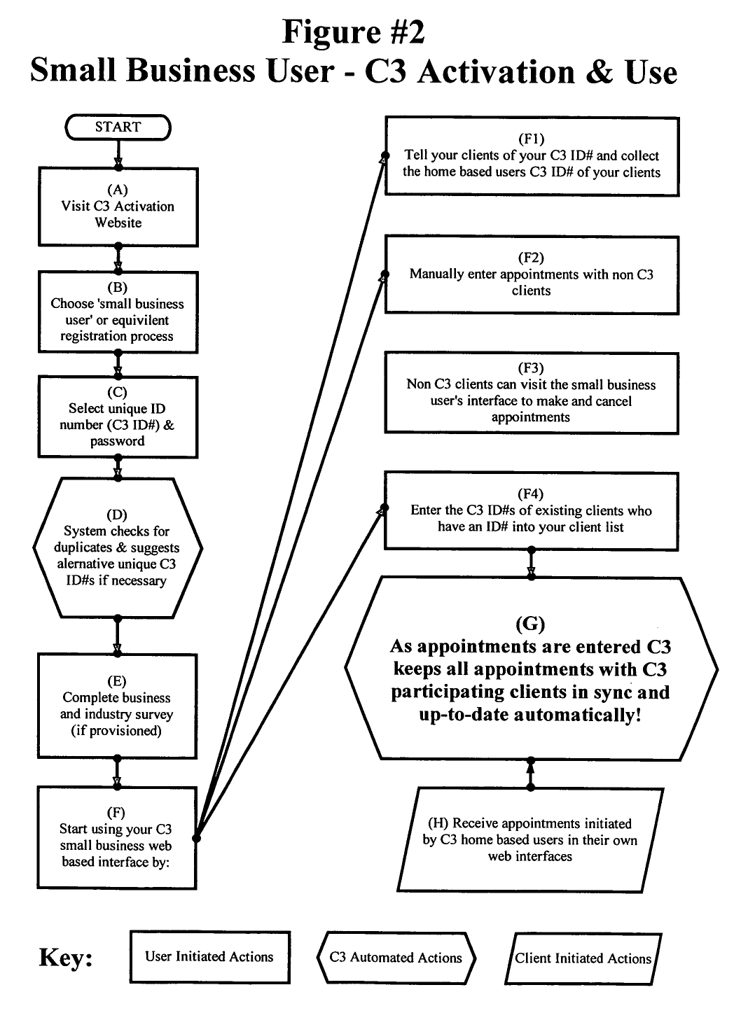

Small business users would follow a similar registration path as home based users (FIG. 2-B-D). Though the format of the small business user ID may be the same as for home based users, the system hereby associates the registered entity as a small business user and provides appropriate interfaces for that role, including but not limited to web based interfaces for standard personal computers, handheld computers (PDA's), or cell phones.

Additionally the C3 system may require that a small business user complete a business and industry survey (FIG. 2-E) to complete the registration process, the data from which could be used in any targeted advertising engine operated by the system.

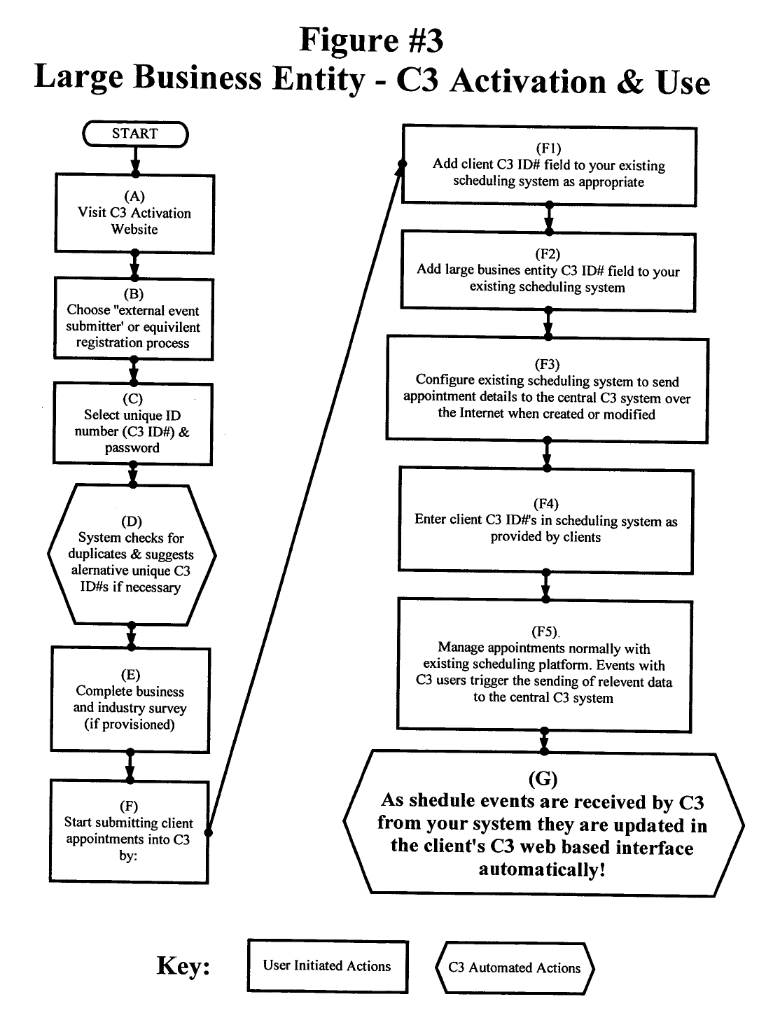

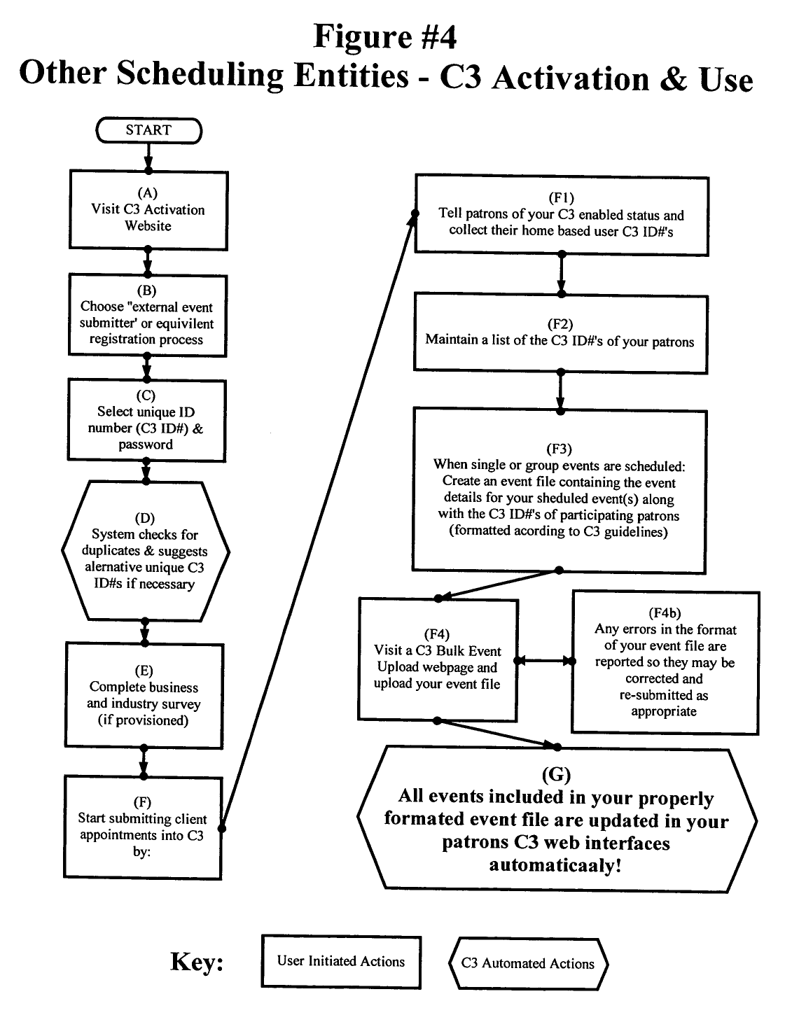

The operators of additional user classes (large business entities, other scheduling entities and others) would follow a similar registration path as small business users, including the business and industry survey if provisioned (FIGS. 3-4, Steps A-E). The system may register these users as a class that does not require a small business user web based interface, or may make a small business user web interface available to these users on any and all web platforms, even though their primary communication channel with C3 may not require a web based interface.

Note that when home base users utilize an office communications suite to send work related events to their home based user calendar, they do so as a home based user. The employer does not need to register as any class of user, but the office communications suite does need to specifically support the C3 system as described further.

Once a provision is made for users from each class to register, the C3 system can provide an appropriate user interface to each class as further described with FIGS. 1-5.

Home Based Users Web Based Interface—FIG. 1

FIG. 1 detailing the activation and use of C3 for a home based user generally defines the key functionality of a home based user web interface (FIG. 1-E). The Interface may provide a graphical calendar representation of any acceptable form, and may offer a choice of interface designs based on user preference. The Interface shall allow a way to manually enter scheduled events of all types for events not associated with C3 entities (FIG. 1-E1) as is typical of existing web based calendar or PIM software. Additionally the home based user web interface may offer other tools and features as appropriate for the organization and operation the home (e-mail, chat, IM, mailing lists etc). The home based user shall use their C3 ID# and password pair for initial authentication to their web interface as is common practice. Alternate interfaces for different classes of web enabled products (Personal Digital Assistants and cell phones etc.) can be offered with the same or limited functionality as possible.

The true benefits of the C3 system are realized as home based users share their C3 ID# with other C3 users to facilitate the automatic sharing or synchronization of calendar data (FIG. 1-E3). They may share their C3 ID# manually (FIG. 1-E3a) or automatically (FIG. 1-E3b) depending on the situation. Additionally, if a family member uses a C3 enabled office communications suite at work, they can enter their C3 ID# and password into that system (FIG. 1-E2) to facilitate synchronization of appropriate work related appointments.

When a new appointment is received from any other C3 entity, the user may be provided with an option to “Accept all appointments from this user” or “Accept only this appointment from this user” or alternately “Reject all appointments from this user” or “Reject only this appointment from this user”. This allows the home based user to control which C3 participants can get events into their active calendar.

Home based users are also able to request additional C3 ID#s for different family members (FIG. 1-F). These ID #s may be based on the main household ID (with a 1,2,3 at the end etc.) or may be completely unique strings. The main feature is that anyone logging in with the main family account can see all events for all associated additional C3 ID#s. These additional ID's may or may not have their own password to access a C3 view with just their appointments. Appropriate view filters should be provided to show, for example, all appointments for all family members at the same time with different colors for each family member, or to show just a single family members appointments or combinations thereof.

All of the functionality detailed in sections a) through e) of the BACKGROUND OF INVENTION—OBJECTS AND ADVANTAGES are possible for home based users and are detailed in the corresponding preferred embodiments for other user classes.

While most of the automated functionality for home based users comes when other classes of users send calendar events into the home calendar, C3 would also allow home based users to initiate appointments with other home based users (FIG. 1-H) as well as small business users (FIG. 2-H). A home based user should be able to select one (or more) of these entities in their web based interface and trigger a ‘make new appointment’ feature that will bring up a view showing available times for the selected user(s). It would not need to show the specifics of events in the other party's calendars, as that info may be sensitive and is not necessary to the task. Once the home based user chooses an appropriate time and event duration with no conflicts, the appointment is entered in the calendar for both or all parties. Note that the other home based user or small business user may need to enable sharing with a specific home based user before this two way feature will work with them.

Two way communications of events could technically be possible with any class of user based on the needs of the user in question. Since other user classes typically maintain their own scheduling system, however, their complete event data is not present in the central C3 system. (Home based users and small business users use C3 as their primary interface, so all data is available to the central C3 system for managing and displaying availability and appointment conflicts etc). Additional communications specifications would need to be created beyond those discussed in the present patent application to enable two way communications with other C3 user classes as an additional extension of C3.

The home based user web based interface can accommodate both overt and discrete advertising integrated in the display of various features to generate a revenue stream for the entity hosting a C3 system as is common practice for many web based applications. Additionally, this advertising can be targeted to match topics suggested by the business and industry survey data for the entities originating scheduled events. The home based user web based interface could also be supported by a fee for use model, but this has proven less successful for web based applications.

Small Business Users Web Based Interface—FIG. 2

FIG. 2 detailing the activation and use of C3 for a small business user generally defines the key functionality of a small business user web interface (FIG. 2-F). The Interface may provide a graphical calendar representation of any acceptable form, and may offer a choice of interface designs based on user preference. The Interface shall allow a way to manually enter appointments of all types for activities not associated with C3 entities (FIG. 2-F2) and maintain a contact list of clients as is typical of existing web based business calendar software. The interface may also allow client users who are not also C3 users to visit the small business user's C3 webpage and make or cancel appointments with the small business user (FIG. 2-F3). Additionally the small business user web interface may offer other tools and features as appropriate for the organization and operation of a small business (e-mail, basic appointment accounting, mailing lists, the ability to view or manage a co-worker's schedule etc). Small business users shall use their C3 ID# and password pair for initial authentication to their web interface as is common practice. Alternate interfaces for different classes of web enabled products (Personal Digital Assistants and cell phones etc.) can be offered with the same or limited functionality as possible.

Similar to home based users, the power of C3 for small business users comes from integration with their clients. Once a small business user's C3 account is activated, they would publicize their C3 participation with clients and collect the C3 ID#s of clients who use the system (FIG. 2-F1). The C3 ID# of clients can be added to the client list (FIG. 2-F4) so that all future appointments with C3 clients trigger synchronization with their home based user calendar.

The small business user may designate their regular business hours in the interface and also block out lunch breaks, vacations, or other standard times that are available or unavailable to clients. Once this is completed they can enable sharing of their calendar to facilitate the two-way scheduling feature available to home based users (FIG. 2-H).

A small business user may also choose to utilize the C3 system in the manner of a home based user as well. Specifically, they may share their C3 ID# with other classes of C3 users to facilitate synchronization with their calendar systems. In this manner, a small business user could have a personal doctor's appointment from a Large Business Entity or a lunch date with a home based user appear in their business calendar.

The small business user web based interface can accommodate both overt and discrete advertising integrated in the display of various features to generate a revenue stream for the entity hosting a C3 system as is common practice for many web based applications. Additionally, this advertising can be targeted to match topics suggested by the business and industry survey data the small business user submitted during registration. Advertising can also be targeted based on the events small business users schedule with other entities who have completed the business and industry survey.

The small business user web based interface could also support a fee for use model. Functionality could be divided into a light version supported by advertising and a full version supported by a fee for service and including more complete small business management tools. All of the scheduling functionality detailed in all sections of this patent application should be included with the free, or advertising supported version to maximize that functionality for all users.

Communications Interfaces

In addition to the two web based interfaces provided for home based users and small business users, the C3 system incorporates additional communications layers allowing other entities to send scheduling data into the C3 system. The first of these systems is comprised of an Applications Program Interface, commonly referred to as an API. An API is a standard communications interface specification that can be shared with partners or the general public to allow integration with a system. The requirements of an API to facilitate the functionality detailed in this patent application are very straightforward and are discussed in more detail later in the application. The applications program interface provided by the C3 system will further be referred to as the C3 API. A C3 API would allow any third party software product to exchange scheduling information with the central C3 system.

An additional interface available for third parties to send data into the C3 system is accomplished by the use of a C3 event file and associated C3 Upload webpage or other mechanism, allowing the processing of many events for many users at once. The C3 event file would be a simple text file of common format for exchanging lists of data (comma separated value (CSV) or tab delimited file etc.). The only required data would be the C3 ID# of each client followed by the date, time, location, duration etc. for the desired event. The exact data elements required by the C3 system may vary and include optional elements for more detail when necessary. A registered C3 entity could create an appropriately formatted C3 event file via any means, then visit a C3 upload webpage to send this file into the C3 system for processing.

The inclusion of these two communications methods provides tremendous flexibility to all entities wishing to interface with the C3 system in some way. The subsequent listed components of the C3 system all make use of one or both of these methods.

Large Business Entities—FIG. 3

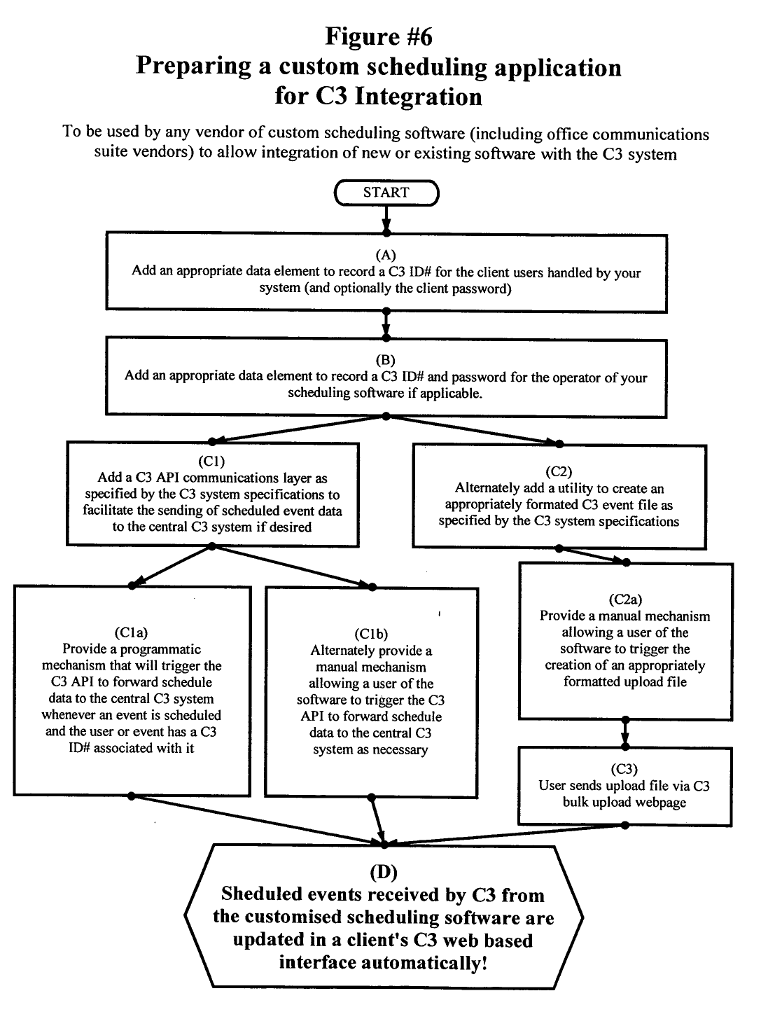

Utilization of the C3 system for large business entities is a straightforward process requiring some up front work to get connected. A large business entity can generally be considered to maintain their own customized scheduling system, however, they may alternately use a commercial scheduling system provided by a third party. If a large business entity maintains their own system, they would follow the steps as detailed in (FIG. 3-F) to prepare said system for C3 use. If a large business entity uses a third party product, the vendor of their software platform will need to customize said software as in “FIG. 6—Preparing a custom scheduling application for C3 integration” as appropriate for the large business entity's use of C3.

If customizing their own scheduling platform, the large business entity must add an appropriate element or data field to their scheduling system to maintain the C3 ID# of client contacts (FIG. 3-F1). This data element may be tied to a client record (if a complete list of clients is maintained) or to the record for specific scheduled events (if clients may make ad-hoc appointments without a permanent client record stored in the system). Additionally a record shall be added to the scheduling software to hold the C3 ID# and password of the large business entity (FIG. 3-F2). This data will be passed to the central C3 system at the beginning of all Internet communications via the C3 API to verify the identity of the large business entity.

The large business entity's scheduling software must further be configured to trigger an outbound C3 API communications event to the central C3 system whenever an appointment is entered in their system and a C3 ID# is present for the party of said appointment (FIG. 3-F3).

Home based users should be given the opportunity to provide their C3 ID# from all contact points in the large business entity's scheduling system (call center operator, client services web interface etc.) to easily facilitate collection of client C3 ID#s (FIG. 3-F4).

When set up accordingly the large business entity may now begin to send appropriate appointment data to C3 clients. Their software system should operate as normally, with their usual business practices and procedures for making and modifying appointments unchanged (FIG. 3-F5), but with a transparent C3 API data exchange to the central C3 system triggered for each relevant appointment with C3 enabled clients.

Other Scheduling Entities—FIG. 4

The category encompassing other scheduling entities is a broad class of users that does not maintain their own scheduling system. These entities may use software for their industry provided by a third party, or may use their own ad-hoc tracking methods (an office suite database or spreadsheet). If an other scheduling entity uses a third party product, the vendor of their software platform will need to customize said software as in “FIG. 6—Preparing a custom scheduling application for C3 integration”. If an other scheduling entity keeps track of their own schedules with ad-hoc methods, or their scheduling software vendor does not yet support C3 integration, they can use the C3 event file upload facility provided by the C3 system.

Once an other scheduling entity has their own C3 ID# (FIG. 4, A-E) they can send client appointment data into the C3 system by creating an appropriately formatted C3 event file (FIG. 4-F). The first step as with all C3 users is to publicize their participation in C3 and collect a list of C3 ID#s from their C3 participating clients (FIG. 4-F1). Since they may have no coherent scheduling software they may need to maintain this list in an appropriate separate application (spreadsheet or database) for use when needed to create an event file (FIG. 4-F2).

When the other scheduling entity plans an event or group of events effecting one or many clients, the C3 event file can be created manually (FIG. 4-F3). Once a C3 event file is created, the other scheduling entity just needs to visit the C3 bulk event upload web interface (FIG. 4-F4). This webpage should first authenticate the user with their C3 ID# and password, then provide a common feature whereby the user can browse their local computer for the location of the C3 event file, then select ‘Upload’ to have it copied to the C3 system for processing.

If the uploaded C3 event file contains any formatting errors the file may be completely rejected or partially rejected based on the severity of the error. In either case, feedback shall be provided to the other scheduling entity so that they can correct the C3 event file and re-upload it as necessary (FIG. 4-F4b). The details of uploaded events will appear automatically in the C3 web based interface for all home based users included in the C3 event file.

Due to the effort and time that may be necessary to create a C3 event file, this method of synchronization is more suited to organizations that do not process a large number of dynamic events. A hobby club that has four ‘jamboree’ events a year or a youth sports league that generates a high volume of scheduling data all at once would be likely candidates to successfully integrate their processes with the C3 system via the uploaded C3 event file. Doing so will provide tremendous convenience benefits to their members.

An appointment may be considered a meeting where two or more parties are expected to attend, while an event is an activity that will be held and attendance may be considered optional (like a quilting bee or a car show). C3 would treat both types of scheduling objects the same and an event file could contain both types. Both an appointment and an event may be referred to as being between two parties even if multiple parties are invited to an event. The intent of sending event data via C3 is to alert all subscribers of the event details so that they can attend if they choose.

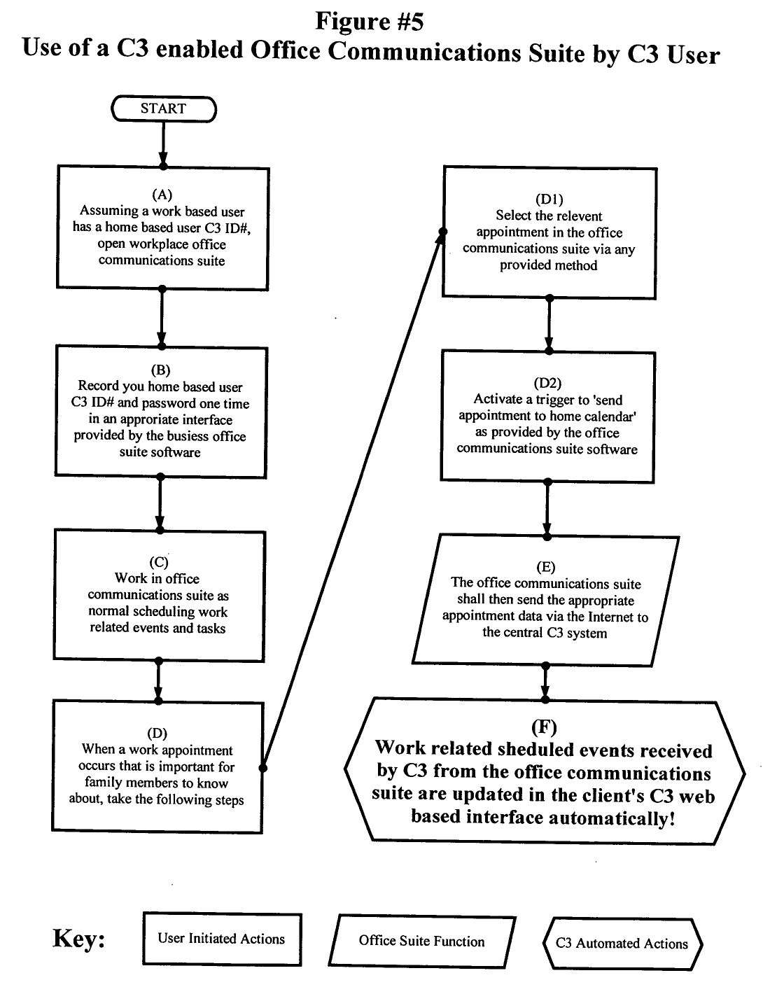

Office Communication Suite Integration—FIG. 5

If a home based user also uses an office communications suite at work, and the suite has C3 functionality enabled, they may use features of the office communications suite to send work related appointments to the home based calendar. Vendors of office communications suite products will need to include appropriate back end communications functionality as detailed with “FIG. 6—Preparing a custom scheduling application for C3 integration”. Additionally the office communications suite vendor shall provide the appropriate features to the end users of their systems as necessary to trigger ‘work to home’ integration as described.

An office communications suite user shall have a method to enter their home based user C3 ID# and password for storage in the office communications suite (FIG. 5-B). They can otherwise work in the office communications suite managing their work related meetings and tasks as normal (FIG. 5-C). When a work appointment occurs that may have relevance to the family (a late work meeting for example) the user can select to send that event for inclusion in the home based user calendar (FIG. 5-D). This is accomplished by selecting the appointment in the office communications suite via any provided method (FIG. 5-D1) then activating a “send to home calendar” trigger again via any provided method (FIG. 5-D2). The relevant appointment would then be sent by the office communications suite to the central C3 system via the C3 API for inclusion in the home based user's web interface (FIG. 5-E).

Modifying Scheduling Software to Integrate with C3—FIG. 6

As stated previously, some classes of users who wish to communicate with clients via the C3 system may use scheduling software provided by a third party vendor. These third party software vendors can modify their existing systems, or create new systems to enable C3 integration for their software products, and hence their clients, as outlined in “FIG. 6 Preparing a custom scheduling application for C3 Integration”

The needs of users utilizing third party scheduling platforms vary widely, so third party vendors should have flexibility in how to configure their products to meet their client's needs. For instance, the client entity using the scheduling software (a school athletic department for example) may need to sign up for their own C3 ID# so that events they submit accurately show their origin (football games show “XYZ High School Athletic Department” as the originator of the appointment). Alternatively, there may not be a need for the client entity to identify themselves directly, as in the case of an office communications suite where the end user triggered appointment exchange can just show the actual end user as the originating party, and not “ABC Incorporated”. Subsequently, the third party software may or may not need to collect a C3 ID# and password of the software operator (FIG. 6-B).

The third party scheduling software will need an interface and data element to record the C3 ID# of home based users that the client entity using the software services (FIG. 6-A). If the client entity using the scheduling software will maintain a C3 ID# and password for identification within C3, they will use that identification data for authentication during the C3 API communications exchanges with the Central C3 system. In this case, the password of home based users will not need to be collected (FIG. 6-A). If events will appear as if originating from the home based user, the password of each home based user will need to be recorded in the third party software along with the home based user C3 ID# (FIG. 6-A).

Based on the sophistication of a third party's software or the needs of their clients, the third party vendor may or may not want to include the C3 API communications layer to send C3 appointment data to the central C3 system automatically (FIG. 6-C1). They may choose instead to automatically format a C3 event file as necessary for specific events (FIG. 6-C2), provide a manual trigger for the creation of the upload file (FIG. 6-C2a) and have the software user upload the file via the C3 bulk upload web interface (FIG. 6-C3).

If utilizing the C3 API to send C3 appointment data to the central C3 system, they may want the data transaction triggered automatically every time a relevant appointment is scheduled (FIG. 6-C1a), or may want to send data to C3 only for specific appointments with a manual trigger (FIG. 6-C1b).

Scheduling software vendors, therefore, have tremendous flexibility in how they choose to implement C3 compatibility.

API Interface

At this point it is appropriate to further discuss the requirements of the C3 API communications layer allowing the transmission of relevant appointment data from various business user classes to the central C3 system. As stated elsewhere, the initial specification for this communications path includes methods for one way communications only. The C3 system does not hold all data for most classes of business entities (except for small business users) and will not initially need to send scheduling data into these systems. Additionally business entities may not welcome the prospect of a third party accessing and modifying the data in their internal systems.

There currently exist a host of communications protocols available via the Internet to facilitate the simple data transactions necessary for the C3 system. The main requirement is that the protocol allow for an authentication step, followed by a data transmission with appropriate feedback to the sending system that all data was received and no formatting or other errors were present in the transmission. Any protocol capable of meeting these needs would be suitable for hosting the C3 API communications channel.

This type of transaction is often accomplished through the use of standard HTML (hyper transport markup language) transactions and their extensions. This can be thought of as a web based transaction, as it uses the same protocols and specifications used for transporting web pages, but the communication is handled transparently by the software. No user intervention is required and no data or information is displayed for an end user in a web browser. Programming extensions for HTML and other web communications are also widely available for almost all current generation software development platforms making this a convenient method for developers implementing the C3 communications layer. Additionally, most organizations have existing mechanisms in place to allow web based transactions to pass through the security layers (firewall) between their private network and the Internet. This also would simplify implementation of the C3 API. The C3 system detailed in this patent application would have no requirements preventing implementation of a C3 API utilizing HTML or web based communications by a qualified technician.

The actual data sets necessary to adequately send appointment or event data to the C3 system is also very simple. At a minimum, the data transaction should include a data element for each of the following fields: the appointment holders C3 ID#, appointment date, appointment time, appointment location, appointment duration, appointment description & the name of the party that appointment is with. Of these fields, all but the C3 ID#, date, and time can be optional as those are all that is required to establish a complete appointment record. The identity of the sending entity is included with the authentication step so is not required in the actual appointment data. A health care provider, for example, would be identified as such by the fact that the API was initiated by ‘Global Health Providers’ and may choose not to include the name of the actual doctor that the appointment is with for confidentiality reasons. Just knowing that you have an appointment at a specific date and time with that organization is enough at a minimum to get you there correctly.

The C3 API should have the capacity to accept additional fields where the business entity has a requirement to send additional information with an appointment record. All web based interfaces for end users should have an accompanying method to display this additional data if provided.

Advantages

From the description above, a number of advantages of my connected community calendar Internet based application become evident

The benefits of two way communications between home based users and small business users are enormous. It provides an inherent ability to manage all manner of appointment making situations with a speed and ease not possible with any currently available means. Appointments can be made quickly and accurately no matter which party has access to the system. The ability of a client to call a business and say “I want to make an appointment next Thursday, but I might have another commitment. Can you call up my calendar and see if I am free between 2:00 PM and 4:00 PM? . . . ” is a distinct advantage in attracting clients for the business user. Likewise the ability for a client to see when their gardener is free via a cell phone C3 interface and book an appointment for a week from Monday is inherently valuable to both the client and the gardener, and the appointment will show up in both systems immediately. Appointments can be made and transmitted to both parties when the user thinks of it, weather they are home, at work or on the road.

Additionally

(a) The connected community calendar automates as many organizational processes as possible for the home based user

(b) The connected community calendar automates as many organizational processes as possible for the small business user.

(c) The availability of flexible interfaces provides a conduit for all prospective scheduling partners to stay connected as needed.

(d) Each of the detailed interfaces provides distinct benefits to the organizations that use them, including: improved convenience, improved scheduling accuracy, improved customer support, and more satisfied clients.

(f) As more individuals and businesses adopt use of the connected community calendar, a higher proportion of scheduling activities will be automated (fewer events will need to be added manually)

(g) The entity hosting a connected community calendar system can expect increased advertising revenue due to the targeted advertising component made available by business to client relationships data

### CONCLUSION, RAMIFICATIONS, AND SCOPE

Accordingly, the reader will see that the comprehensive features of the integrated C3 system provide a significant benefit over the non integrated personal calendar systems currently available and also those providing limited integration within the home based user class only.
The availability of varied interfaces to suit the needs of different user classes, all intended to seamlessly interact with a home based user's web based personal information management tool, provides a level of convenience not possible with existing products.
The highly automated nature of the connected community calendar should draw users away from other web based calendar systems, which are currently chosen primarily on the basis of look and feel as opposed to advanced functionality. The C3 web based can support multiple look and feel options to meet the tastes of different users so there should be no problem competing on that basis.
Growth in the adoption of the connected community calendar will continually increase the level of automation for all users. In other words, as more individuals and businesses adopt use of the connected community calendar, a higher proportion of scheduling activities will be automated (fewer events will need to be added manually), driving more use of the products.
As use of the connected community calendar grows, so will the revenue potential of the advertising system, both through increased use and as the targeted advertising engine becomes more accurate via the accumulation of more data.

Although the description above contains many specificities, these should not be construed as limiting the scope of the invention, but as merely providing illustrations of some of the presently preferred embodiments of this invention. For example, an authentication method may arise allowing Internet based transactions to be authenticated without a traditional password. Authentication via this method could be substituted where the specifications call for a username & password without affecting the unique and beneficial attributes of the current patent application.

Thus the scope of the invention should be determined by the appended claims and their legal equivalents, rather than by the examples given.

I claim:

1. A method for integrating the scheduling systems of multiple user classes comprising:
(a) providing an internet based personal information management interface for a home based user suitable for the organization of a personal or family schedule
(b) providing a plurality of internet based tools for other classes of users to exchange pertinent scheduling information with the home based user's interface.
whereby all appointments between said home based user and said other classes of users are updated in the home based user's interface in an automated fashion.

2. The method for integrating the scheduling systems of multiple user classes of claim 1 further providing an internet based personal information management interface for a small business user suitable for the organization of business contacts and appointments and capable of exchanging pertinent scheduling information with the home based user's interface whereby all appointments between said home based user and said small business user are updated in both the home based user's interface and the small business user's interface in an automated fashion.

3. The method for integrating the scheduling systems of multiple user classes of claim 2 further providing an internet based API allowing any external software product to exchange pertinent scheduling information with the home based user's interface whereby all appointments between said home based user and an operator of said third party software product are updated in the home based user's interface in an automated fashion.

4. The method for integrating the scheduling systems of multiple user classes of claim 3 further providing an interface allowing an organization to upload via the internet a file of predetermined format containing bulk scheduling information related to one or multiple home based users whereby all appointments or events between said home based user and said organization as detailed in said file are updated in each of the home based user's interfaces in an automated fashion.

5. The method for integrating the scheduling systems of multiple user classes of claim 2 further providing an interface allowing an organization to upload via the internet a file of predetermined format containing bulk scheduling information related to one or multiple home based users whereby all appointments or events between said home based user and said organization as detailed in said file are updated in each of the home based user's interfaces in an automated fashion.

6. The method for integrating the scheduling systems of multiple user classes of claim 1 further providing an internet based API allowing any external software product to exchange pertinent scheduling information with the home based user's interface whereby all appointments between said home based user and an operator of said third party software product are updated in the home based user's interface in an automated fashion.

7. The method for integrating the scheduling systems of multiple user classes of claim 6 further providing an interface allowing an organization to upload via the internet a file of predetermined format containing bulk scheduling information related to one or multiple home based users whereby all appointments or events between said home based user and said organization as detailed in said file are updated in each of the home based user's interfaces in an automated fashion.

8. The method for integrating the scheduling systems of multiple user classes of claim 1 further providing an interface allowing an organization to upload via the internet a file of predetermined format containing bulk scheduling information related to one or multiple home based users whereby all appointments or events between said home based user and said organization as detailed in said file are updated in each of the home based user's interfaces in an automated fashion.

9. An internet based scheduling toolset comprising a calendar interface provided for home based users and a plurality of means for multiple user classes to exchange scheduling information with said toolset whereby all appointments between said home based users and the other user classes are updated in an automated fashion in the home based user's interface.

10. The internet based scheduling toolset of claim 9 further comprising a calendar interface provided for small business users with a means to exchange scheduling information with said toolset whereby all appointments between said home based users and said small business users are updated in both the home based user's interface and the small business user's interface in an automated fashion.

11. The internet based scheduling toolset of claim 10 further comprising a means allowing any external software product to exchange pertinent scheduling information with the toolset whereby all appointments between said home based user and an operator of said external software are updated in the home based user's interface in an automated fashion.

12. The internet based scheduling toolset of claim 11 further comprising a means for an organization to provide a file of predetermined format containing bulk scheduling information related to one or multiple home based users to the toolset whereby all appointments or events between said home based users and said organization as detailed in said file are updated in each of the home based user's interfaces in an automated fashion.

13. The internet based scheduling toolset of claim 10 further comprising a means for an organization to provide a file of predetermined format containing bulk scheduling information related to one or multiple home based users to the toolset whereby all appointments or events between said home based users and said organization as detailed in said file are updated in each of the home based user's interfaces in an automated fashion.

14. The internet based scheduling toolset of claim 9 further comprising a means allowing any external software product to exchange pertinent scheduling information with the toolset whereby all appointments between said home based user and an operator of said external software are updated in the home based user's interface in an automated fashion.

15. The internet based scheduling toolset of claim 14 further comprising a means for an organization to provide a file of predetermined format containing bulk scheduling information related to one or multiple home based users to the toolset whereby all appointments or events between said home based users and said organization as detailed in said file are updated in each of the home based user's interfaces in an automated fashion.

16. The internet based scheduling toolset of claim 9 further comprising a means for an organization to provide a file of predetermined format containing bulk scheduling information related to one or multiple home based users to the toolset whereby all appointments or events between said home based users and said organization as detailed in said file are updated in each of the home based user's interfaces in an automated fashion.

17. An internet based system providing a plurality of automated tools linking all parties relevant to the automated maintenance of scheduled events between said parties comprising
(a) a web based interface for home based users suitable for the organization of a personal or family schedule
(b) a web based interface for small business users suitable for the organization of business contacts and appointments
whereby appointments and events between all parties are kept updated in all provided interfaces to the extent possible.

18. The internet based system of claim 17 further comprising a means for external scheduling software to provide data into said internet based system whereby the schedule data is reflected automatically in the home based user's interface or the small business user's interface as appropriate.
